(19) United States
(12) Patent Application Publication
(10) Pub. No.: US 2026/0098235 A1
(43) Pub. Date: Apr. 9, 2026

(54) CLEANING SOLUTION FOR INKJET RECORDING APPARATUS

(71) Applicant: KYOCERA DOCUMENT SOLUTIONS INC., OSAKA (JP)

(72) Inventor: SHUNTA EHARA, OSAKA (JP)

(21) Appl. No.: 19/351,310

(22) Filed: Oct. 7, 2025

(30) Foreign Application Priority Data
Oct. 7, 2024 (JP) 2024-175974

(51) Int. Cl. C11D 3/43; C11D 1/82; C11D 1/90; C11D 3/37

(52) U.S. Cl. CPC C11D 3/43; C11D 1/82; C11D 1/90; C11D 3/3757; C11D 2111/22

(57) ABSTRACT

A cleaning solution is a cleaning solution for an inkjet recording apparatus, including: water, a surfactant, two or more types of water-soluble organic solvents, and a carboxylic acid salt other than the surfactant. The two or more types of water-soluble organic solvents include at least polyethylene glycol. A Hansen solubility parameter distance between the polyethylene glycol and the carboxylic acid salt is 10 or less.

### CROSS-REFERENCE TO RELATED PATENT APPLICATION

This application claims the benefit of Japanese Priority Patent Application JP 2024-175974 filed Oct. 7, 2024, the entire contents of which are incorporated herein by reference.

### FIELD OF THE DISCLOSURE

The present disclosure relates to a cleaning solution for an inkjet recording apparatus.

### BACKGROUND OF THE DISCLOSURE

An inkjet recording apparatus forms an image on a recording medium by ejecting an ink for inkjet recording from an ejection surface of a recording head. A cleaning method is known in which a cleaning solution is supplied to the ejection surface and the ejection surface is wiped with a wiping blade to remove the stains caused by the ink remaining on the ejection surface (e.g., Japanese Patent Application Laid-open No. 2018-202746).

Meanwhile, as the ink used in the inkjet recording apparatus, an ink containing a binder resin is used in some cases from the viewpoint of enabling printing on a low absorption recording medium such as coated paper or a non-absorbent recording medium such as a resin film. For example, Japanese Patent Application Laid-open No. 2016-216542 discloses a cleaning solution containing a carboxylic acid salt such as an ethylenediaminetetraacetic acid (EDTA) salt and a nitrilotriacetic acid salt of ethylenediamine from the viewpoint of removing foreign substances derived from such a resin of the ink, and the like.

### SUMMARY OF THE DISCLOSURE

According to an embodiment of the present disclosure, there is provided a cleaning solution for an inkjet recording apparatus, including:
water; a surfactant; two or more types of water-soluble organic solvents; and a carboxylic acid salt other than the surfactant.

The two or more types of water-soluble organic solvents include at least polyethylene glycol.

A Hansen solubility parameter distance between the polyethylene glycol and the carboxylic acid salt is 10 or less.

### DETAILED DESCRIPTION OF THE EXEMPLARY EMBODIMENTS

The cleaning solution including a carboxylic acid salt is expected to enhance the cleaning power against dried and adhered ink stains. Meanwhile, since most of the carboxylic acid salts are generally solid compounds at normal temperature and normal pressure, there has been a risk that when the cleaning solution including a carboxylic acid salt remains on the ejection surface or the like, solids derived from the carboxylic acid salt precipitate.

In view of the circumstances as described above, it is an object of the present disclosure to provide a cleaning solution for an inkjet recording apparatus capable of suppressing the precipitation of solids in the cleaning solution remaining on the inkjet recording apparatus.

An embodiment of the present disclosure will be described below. Note that in the following description, the expression “content of B in A” refers to the mass ratio of B when the mass of A is 100 mass %. Further, the components described in the present specification may each be used alone, or two or more of them may be used in combination.

### [Cleaning Solution for Inkjet Recording Apparatus]

The cleaning solution according to this embodiment is a cleaning solution for an inkjet recording apparatus. The cleaning solution is used to clean the ink remaining on the inkjet recording apparatus and the like, and may be, for example, a cleaning solution for cleaning the ejection surface of the recording head mounted on the inkjet recording apparatus onto which ink is ejected. In this embodiment, cleaning of the ejection surface includes removing ink stains adhered to the ejection surface and the like, and is, for example, supplying the cleaning solution to the ejection surface and wiping the ejection surface with a wiping member such as a blade. Alternatively, the cleaning solution can be used to clean not only the ejection surface but also the blade used in the wipe operation, the conveying roller, and the like.

The cleaning solution according to this embodiment includes water, a surfactant, two or more types of water-soluble organic solvents, and a carboxylic acid salt other than the surfactant.

### (Water)

The content of water in the cleaning solution according to this embodiment is appropriately set in accordance with the contents of other components, and is favorably 40.0 mass % or more and 90.0 mass % or less, more favorably 60.0 mass % or more and 80.0 mass % or less.

### (Surfactant)

The cleaning solution according to this embodiment may include one or two or more types of surfactants used in the present technical field. Examples of the surfactant include a cationic surfactant, an anionic surfactant, an amphoteric surfactant, and a nonionic surfactant. Of these, favorably at least one selected from the group consisting of an amphoteric surfactant and a nonionic surfactant, more favorably an amphoteric surfactant having a betaine structure and/or a silicone surfactant, still more favorably an amphoteric surfactant having a betaine structure, is included as a surfactant in the cleaning solution according to this embodiment.

### (Amphoteric Surfactant Having Betaine Structure)

The amphoteric surfactant having a betaine structure has excellent performance in adhering to the surroundings of stains (a pigment, a resin component, and the like) fixed to a cleaning target (e.g., the above ejection surface) to release the stains from the cleaning target and excellent performance in dispersing the released stains in the cleaning solution. Note that the betaine refers to an intramolecular salt having a cationic structure (e.g., a quaternary ammonium ion structure) and an anionic structure (e.g., an anionic structure of an acid such as carboxylic acid) in one molecule. As the amphoteric surfactant having a betaine structure, an amphoteric surfactant having an amidoalkyl betaine structure is favorable. As the amphoteric surfactant having an amidoalkyl betaine structure, a compound represented by the following general formula (1) is favorable.

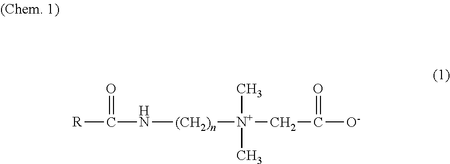

In the general formula (1), R represents a monovalent chain hydrocarbon group having 6 or more and 20 or less carbon atoms. n represents an integer of 1 or more and 5 or less.

R favorably represents a monovalent chain hydrocarbon group having 10 or more and 18 or less carbon atoms. Examples of the monovalent chain hydrocarbon group represented by R include a chain alkyl group and a chain alkenyl group. n favorably represents 3.

Examples of the amphoteric surfactant having an amidoalkyl betaine structure include a fatty acid amidopropyl betaine surfactant. Examples of the fatty acid amidopropyl betaine surfactant include coconut oil fatty acid amidopropyl betaine, lauramidopropyl betaine, palm kernel fatty acid amidopropyl betaine, isostearic acid amidopropyl betaine, and linoleic acid amidopropyl betaine. As the amphoteric surfactant having an amidoalkyl betaine structure, coconut oil fatty acid amidopropyl betaine, lauramidopropyl betaine, or palm kernel fatty acid amidopropyl betaine is favorable.

The content of the amphoteric surfactant having a betaine structure in the cleaning solution is favorably 0.05 mass % or more and 3.0 mass % or less, more favorably 0.1 mass % or more and 2.0 mass % or less, from the viewpoint of imparting excellent cleaning performance to the cleaning solution.

### (Silicone Surfactant)

The silicone surfactant reduces the surface tension of the cleaning solution, making the cleaning solution easier to penetrate into stains. The silicone surfactant means a surfactant having a siloxane bond. As the silicone surfactant, a polyether-modified silicone surfactant is favorable and a polyether-modified polydimethylsiloxane is more favorable.

In the cleaning solution, the content of the silicone surfactant is favorably 0.05 mass % or more and 1.5 mass % or less, more favorably 0.1 mass % or more and 1.0 mass % or less, from the viewpoint of imparting appropriate surface tension to the cleaning solution.

In the cleaning solution, the total content of the amphoteric surfactant having a betaine structure and the silicone surfactant is favorably 0.1 mass % or more and 5.0 mass % or less, more favorably 0.2 mass % or more and 3.0 mass % or less.

### (Water-Soluble Organic Solvent)

In this embodiment, the water-soluble organic solvent includes at least polyethylene glycol and at least one type of water-soluble organic solvent. Note that the water-soluble organic solvent in the present disclosure refers to an organic solvent having solubility in water of 1.0 mass % or more at 25° C.

Polyethylene glycol is a polyhydric alcohol having a structure in which ethylene glycol is polymerized and has the physical properties of a low vapor pressure and easily maintaining a liquid state. When a cleaning solution includes polyethylene glycol, the remaining cleaning solution is more likely to maintain the liquid state even in a harsh environment in which the components of the cleaning solution tend to evaporate. Further, it is conceivable that when polyethylene glycol in the cleaning solution satisfies the condition of a Hansen solubility parameter distance with a carboxylic acid salt described below, the solubility of a carboxylic acid salt that easily precipitates can be increased and the precipitation of the carboxylic acid salt can be suppressed.

The lower limit of the average molecular weight of polyethylene glycol is favorably 150 or more, more favorably 200 or more, from the viewpoint of reducing the Hansen solubility parameter distance to enhance the solubility of the carboxylic acid salt. Further, the upper limit of the average molecular weight of polyethylene glycol is not particularly limited as long as the Hansen solubility parameter distance with a carboxylic acid salt described below can be 10 or less, but is favorably 350 or less, more favorably 300 or less, from the viewpoint of enhancing the cleaning power in cooperation with the other components. Note that the average molecular weight of polyethylene glycol is a number average molecular weight (Mn) and is a value measured using gel permeation chromatography.

The upper limit of the content of polyethylene glycol in the cleaning solution is favorably 3.0 mass % or less, more favorably 2.5 mass % or less, from the viewpoint of imparting appropriate physical properties (e.g., viscosity, and surface tension) to the cleaning solution. Further, the lower limit of the content of polyethylene glycol in the cleaning solution is favorably 1.0 mass % or more, more favorably 1.5 mass % or more, from the viewpoint of suppressing the drying of the cleaning solution remaining on the inkjet recording apparatus.

Examples of the water-soluble organic solvent other than polyethylene glycol include a polyhydric alcohol other than polyethylene glycol, glycol ether, a lactam compound, a nitrogen-containing compound, an acetate compound, thiodiglycol, and dimethylsulfoxide.

Examples of the polyhydric alcohol other than polyethylene glycol include a glycol compound and glycerin. Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of glycol ether include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compound include 2-pyrrolidone and N-methyl-2-pyrrolidone.

Examples of the nitrogen-containing compound include 1,3-dimethylimidazolidinone, formamide, and dimethylformamide.

Examples of the acetate compound include diethylene glycol monoethyl ether acetate.

The lower limit of the total content of the water-soluble organic solvent in the cleaning solution is favorably 10.0 mass % or more, more favorably 15.0 mass % or more, from the viewpoint of imparting appropriate physical properties (viscosity, surface tension, and the like) to the cleaning solution. Further, the upper limit of the total content of the water-soluble organic solvent is favorably 40.0 mass % or less, more favorably 35.0 mass % or less, considering the balance with other raw material.

### (Carboxylic Acid Salt)

The cleaning solution according to this embodiment includes the above carboxylic acid salt other than the surfactant. In this embodiment, the carboxylic acid salt has the effect of capturing and absorbing ink stains including the resin component or the like of a cleaning target and removing them, and the chelating effect of capturing metal ions (calcium ions, magnesium ions, polyvalent cations, and the like) that reduce the effects of ionic surfactants and the like, allowing the cleaning power of the cleaning solution to be improved. In particular, a resin component is often added to the ink for an inkjet recording apparatus using a low absorption recording medium such as coated paper and a non-absorbent recording medium such as a resin film as a recording medium in order to ensure fixability of the pigment to the recording medium. When such an ink remains on the ejection surface or the like, the pigment and the resin component are easily fixed as moisture in the ink decreases, making the cleaning difficult. For this reason, by adding a carboxylic acid salt to a cleaning solution, it is possible to impart the effect of capturing and absorbing the fixed ink stains by the electrostatic effect or the like and removing them to the cleaning agent.

The carboxylic acid salt in this embodiment is not particularly limited as long as it is other than the above-mentioned surfactants and satisfies the condition of a Hansen solubility parameter distance described below. Examples of the carboxylic acid salt include a polyacrylic acid salt, a polymethacrylic acid salt, an aminopolycarboxylic acid salt, a hydroxycarboxylic acid salt, a cyclocarboxylic acid salt, an ether carboxylic acid salt, other carboxylic acid salts, and a copolymer including at least one of these carboxylic acid salts as a monomer.

Of these, the carboxylic acid salt according to this embodiment favorably includes a polymer or copolymer including an acrylic acid salt as a monomer (hereinafter, referred to as an “acrylic acid water-soluble polymer”). Examples of such a carboxylic acid salt include a polyacrylic acid salt, an acrylic acid/maleic acid copolymer salt, and an acrylic acid/sulfonic acid monomer copolymer salt. Of these, a polyacrylic acid salt is favorable. When the cleaning solution includes an acrylic acid water-soluble polymer, particularly a polyacrylic acid salt, a Hansen solubility parameter distance with polyethylene glycol described below can be easily set to 10 or less. As a result, the acrylic acid water-soluble polymer can be sufficiently resolved in polyethylene glycol, thereby suppressing the precipitation of solids derived from the acrylic acid water-soluble polymer in the remaining cleaning solution. Further, the acrylic acid water-soluble polymer allows the effect of capturing and absorbing the pigment and the resin included in the ink that is the cleaning target and removing them to be stably exhibited, which is expected to achieve the effect of enhancing the cleaning power of the cleaning solution.

Note that in this embodiment, the content of the acrylic acid water-soluble polymer in the carboxylic acid salt is favorably 90 mass % or more, more favorably 95 mass % or more, still more favorably 100 mass %. That is, the carboxylic acid salt is favorably formed of the acrylic acid water-soluble polymer.

The lower limit of the content of the carboxylic acid salt in the cleaning solution is favorably 0.1 mass % or more, more favorably 0.3 mass % or more, from the viewpoint of improving the cleaning performance. Further, the upper limit of the content of the carboxylic acid salt is favorably 2.0 mass % or less, more favorably 1.0 mass % or less, from the viewpoint of suppressing the precipitation of the carboxylic acid salt in the remaining cleaning solution.

### (Hansen Solubility Parameter Distance Between Polyethylene Glycol and Carboxylic Acid Salt)

The Hansen solubility parameter (HSP) is a value used to predict the solubility of a substance and is the solubility parameter (SP) introduced by Hildebrand, which is divided into three components, i.e., the dispersion term (dD), the polarization term (dP), and the hydrogen bonding term (dH), and represented on a three-dimensional space. The three parameters (unit: MPa0.5) of HSP are as follows.
Dispersion term (dD): energy due to intermolecular dispersion force.
Polarization term (dP): energy due to intermolecular dipole interaction.
Hydrogen bonding term (dH): energy due to intermolecular hydrogen bond.

The dispersion term (dD) is a term based on the Van Der Waals proximity force. The polarization term (dP) is also called the polarity term and is a term caused by a dipole moment, a dielectric constant, and the like. The hydrogen bonding term (dH) includes an intermolecular force based on a hydrogen bond, a π-π interaction that cannot be classified elsewhere, and the like.

Note that the three components, i.e., the dispersion term (dD), the polarization term (dP), and the hydrogen bonding term (dH), have been extensively explored by Hansen and his successors, and are described in Polymer Handbook (fourth edition), VII-698 to 711 in detail. Further, the definition and calculation of HSP are described in Charles M. Hansen, “Hansen Solubility Parameters: A Users Handbook” (CRC Press, 2007). Further, the Hansen solubility parameter values for many solvents and resins have been investigated and described in, for example, Wesley L. Archer, “Industrial Solvents Handbook”.

The three parameters constituting HSP can be regarded as coordinates in a three-dimensional space (the Hansen space). When two specific substances are placed in the Hansen space, the closer the coordinates of the two substances are, the more similar the properties of the two substances tend to be.

A specific method of predicting the solubility of two substances (e.g., a solvent X and a solute Y) using HSP Will be described. First, the two substances are placed in the Hansen space on the basis of HSP. Then, a distance Ra between the coordinates of the two substances is calculated. The closer the distance Ra is, the more easily the two substances dissolve in each other. The distance Ra between the two substances can be calculated using the following equation (R).

$$( Math . 1 )$$

$${R}_{a} = \sqrt{4 \times {( dDx - dDy )}^{2} + {( dPx - dPy )}^{2} + {( dHx - dHy )}^{2}} \qquad ( R )$$

In the equation (R), dDx, dPx, and dHx respectively indicate the dispersion term (dD), the polarization term (dP), and the hydrogen bonding term (dH) of the solvent X. dDy, dPy, and dHy respectively indicate the dispersion term (dD), the polarization term (dP), and the hydrogen bonding term (dH) of the solute Y.

When this is applied to the cleaning solution according to this embodiment, a distance Rap of the solvent (polyethylene glycol) and the solute (carboxylic acid salt) in the Hansen space is the HSP distance between the polyethylene glycol and the carboxylic acid salt and calculated using the following equation (R-1).

$$( Math . 2 )$$

$${R}_{ap} = \sqrt{4 \times {( dDs - dDp )}^{2} + {( dPs - dPp )}^{2} + {( dHs - dHp )}^{2}} \qquad ( R - 1 )$$

In the equation (R-1), dDs, dPs, and dHs respectively indicate the dispersion term (dD), the polarization term (dP), and the hydrogen bonding term (dH) of the solvent (polyethylene glycol). dDp, dPp, and dHp respectively indicate the dispersion term (dD), the polarization term (dP), and the hydrogen bonding term (dH) of the solute (carboxylic acid salt).

In this embodiment, the HSP distance between the polyethylene glycol and the carboxylic acid salt is 10 or less. The carboxylic acid salt is generally a solid at normal temperature and normal pressure, and there is a possibility that when the cleaning solution remaining on the ejection surface or the like is dried, solids derived from the carboxylic acid salt precipitate. On the other hand, in this embodiment, by setting the HSP distance to 10 or less, the solubility of the carboxylic acid salt in polyethylene glycol can be increased to suppress the precipitation of the carboxylic acid salt included in the cleaning solution, as shown in Examples. Further, the upper limit of the HSP distance between the polyethylene glycol and the carboxylic acid salt is favorably 8.0 or less from the viewpoint of more reliably suppressing the precipitation of the carboxylic acid salt included in the cleaning solution. The lower limit of the HSP distance is not particularly limited as long as both the cleaning performance and the solubility can be achieved, but is favorably 1.0 or more, more favorably 4.0 or more.

### Other Components

The cleaning solution may further include known additives (e.g., a dissolution stabilizer, an anti-drying agent, an antioxidant, a viscosity adjustor, a pH adjuster, and an antifungal agent) as necessary.

### Summary of this Embodiment

As described above, according to the cleaning solution according to this embodiment, by using polyethylene glycol as a water-soluble organic solvent and a carboxylic acid salt having the HSP distance with polyethylene glycol of 10 or less, it is possible to suppress the drying of the cleaning solution remaining on the ejection head and suppress the precipitation of solids. This is presumably because moisturizing properties polyethylene glycol suppresses the drying of the cleaning solution and maintains the state in which the carboxylic acid salt is dissolved in polyethylene glycol, thereby suppressing the precipitation of solids.

Further, when the cleaning solution includes a carboxylic acid salt and polyethylene glycol having an average molecular weight of 150 or more and 350 or less, it is possible to exert the effect of capturing and absorbing the pigment and the resin component included in the remaining ink and removing them, thereby enhancing the cleaning performance of the cleaning solution. In particular, the cleaning solution is capable of stably exhibiting such cleaning performance by including, as a carboxylic acid salt, a polymer or copolymer including an acrylic acid salt as a monomer, e.g., a polyacrylic acid salt. For this reason, the cleaning solution according to this embodiment is suitable for cleaning an inkjet recording apparatus that uses an ink to which a resin component is added to ensure fixability of the pigment to the recording medium, e.g., cleaning an inkjet recording apparatus that uses a low absorption recording medium and a non-absorbent recording medium as recording media.

Although the cleaning solution according to this embodiment has been described above, the present disclosure is not limited to only the above-mentioned embodiment, and various modifications can be made without departing from the essence of the present disclosure.

### EXAMPLES

Although Examples of the present disclosure will be described below, the present disclosure is not limited to Examples below.

### [Preparation of Cleaning Solution]

Cleaning solutions (CLN-1) to (CLN-5) were prepared by the following method. Note that the cleaning solution (CLN-1) was used as a cleaning solution sample according to Comparative Example of the present disclosure and the cleaning solutions (CLN-2) to (CLN-5) were used as cleaning solution samples according to Examples of the present disclosure.

### (Cleaning Solution (CLN-1))

28 parts of 1,3-propanediol (manufactured by MARUZEN GROUP), 2 parts of glycerin (manufactured by FUJIFILM Wako Pure Chemical Corporation), 0.3 parts of AMOGEN (registered trademark) CB-H (manufactured by DKS Co. Ltd.), 0.3 parts of SAG002 (manufactured by Nissin Chemical Co., Ltd.), 0.5 parts of sodium polyacrylate (DL522 (manufactured by NIPPON SHOKUBAI CO., LTD.)), and 68.9 parts of ion exchanged water were added to a container and stirred to prepare a cleaning solution (CLN-1). Of the raw materials, 1,3-propanediol and glycerin are classified as organic solvents. AMOGEN CB-H is classified as an amidobetaine type amphoteric surfactant. SAG002 is classified as a silicone surfactant. Sodium polyacrylate is classified as a carboxylic acid salt.

### (Cleaning Solution (CLN-2))

A cleaning solution (CLN-2) was prepared in the same manner as that for the cleaning solution (CLN-1) except that glycerin was replaced with PEG-200 (manufactured by SANYO CHEMICAL INDUSTRIES, LTD.). PEG-200 is an organic solvent including polyethylene glycols having different molecular weights and has been prepared such that the number average molecular weight is 200.

### (Cleaning Solution (CLN-3))

A cleaning solution (CLN-3) was prepared in the same manner as that for the cleaning solution (CLN-1) except that glycerin was replaced with PEG-300 (manufactured by SANYO CHEMICAL INDUSTRIES, LTD.). PEG-300 is an organic solvent including polyethylene glycols having different molecular weights and has been prepared such that the number average molecular weight is 300.

### (Cleaning Solution (CLN-4))

A cleaning solution (CLN-4) was prepared in the same manner as that for the cleaning solution (CLN-1) except that glycerin was replaced with PEG-400 (manufactured by SANYO CHEMICAL INDUSTRIES, LTD.). PEG-400 is an organic solvent including polyethylene glycols having different molecular weights and has been prepared such that the number average molecular weight is 400.

### (Cleaning Solution (CLN-5))

A cleaning solution (CLN-5) was prepared in the same manner as that for the cleaning solution (CLN-1) except that glycerin was replaced with PEG-600 (manufactured by SANYO CHEMICAL INDUSTRIES, LTD.). PEG-600 is an organic solvent including polyethylene glycols having different molecular weights and has been prepared such that the number average molecular weight is 600.

TABLE 1

| | | Comparative | | | | |
|---|---|---|---|---|---|---|
| | | Example | Example | Example | Example | Example |
| | | CLN-1 | CLN-2 | CLN-3 | CLN-4 | CLN-5 |
| Organic solvent | 1,3-propanediol | 28.0 | 28.0 | 28.0 | 28.0 | 28.0 |
| [parts by mass] | Glycerin | 2.0 | — | — | — | — |
| | PEG-200 | — | 2.0 | — | — | — |
| | PEG-300 | — | — | 2.0 | — | — |
| | PEG-400 | — | — | — | 2.0 | — |
| | PEG-600 | — | — | — | — | 2.0 |
| Surfactant | AMOGEN CB-H | 0.3 | 0.3 | 0.3 | 0.3 | 0.3 |
| [parts by mass] | SAG002 | 0.3 | 0.3 | 0.3 | 0.3 | 0.3 |
| Carboxylic acid salt | DL522 | 0.5 | 0.5 | 0.5 | 0.5 | 0.5 |
| [parts by mass] | | | | | | |

| | | | | | |
|---|---|---|---|---|---|
| Ion exchanged water | Remainder | Remainder | Remainder | Remainder | Remainder |
| Total [parts by mass] | 100.0 | 100.0 | 100.0 | 100.0 | 100.0 |

### [Calculation of HSP Distance]

For the cleaning solutions (CLN-1) to (CLN-5), the Hansen solubility parameter (HSP) distance between polyethylene glycol and the carboxylic acid salt was calculated. The HSP values of glycerin, polyethylene glycol, and sodium polyacrylate used in each cleaning solution sample are shown in Table 2. These values were taken from the publicly available HSP values described in the literatures or the like as described above. Note that although each polyethylene glycol reagent includes polyethylene glycols having different molecular weights as described above, the HSP of polyethylene glycol having a molecular weight closest to the corresponding number average molecular weight was used as an approximation.

TABLE 2

| | dD | dP | dH |
|---|---|---|---|
| Glycerin | 17.4 | 11.1 | 27.2 |
| Polyethylene glycol 200 | 16.7 | 9 | 14.6 |
| Polyethylene glycol 300 | 16.2 | 8.2 | 11.8 |
| Polyethylene glycol 400 | 15.7 | 7.5 | 9.7 |
| Polyethylene glycol 600 | 15.3 | 7 | 8.4 |
| Sodium polyacrylate | 14.9 | 7.6 | 7.4 |

These HSP values were substituted into the above-mentioned equation (R-1) to calculate an HSP distance Rap. Note that for each cleaning solution sample, glycerin or polyethylene glycol was used as a solvent and sodium polyacrylate was used as a solute. The results are shown in Table 3.

As shown in Table 3, the cleaning solution (CLN-1) using glycerin as a solvent had a value of the HSP distance Rap of larger than 10. On the other hand, the cleaning solutions (CLN-2) to (CLN-5) using polyethylene glycol as a solvent had a value of HSP distance Rap of 10 or less, and the HSP distance Rap tended to decrease as the molecular weight of polyethylene glycol increases. From these results, it was found that by using polyethylene glycol having a number average molecular weight of 150 or more, e.g., 200 or more, and sodium polyacrylate, the HSP distance Rap can be 10 or less and miscibility is improved.

TABLE 3

| | | Comparative | | | | |
|---|---|---|---|---|---|---|
| | | Example | Example | Example | Example | Example |
| | | CLN-1 | CLN-2 | CLN-3 | CLN-4 | CLN-5 |
| Miscibility | HSP distance | 20.3 | 7.6 | 4.6 | 2.4 | 1.2 |
| Dryness | Determination | With | Without | Without | Without | Without |
| Cleaning | Removal ratio (%) | 92 | 91 | 94 | 78 | 72 |
| performance | Determination | A | A | A | B | B |

### [Dryness Test]

The cleaning solutions (CLN-1) to (CLN-5) were placed in petri dishes and left to stand in a constant temperature bath at 60° C. for 2 weeks. The petri dishes were taken out after two weeks, the dryness of each cleaning solution was evaluated on the basis of the following evaluation criteria. The results are shown in Table 3.

### (Dryness Criteria)

“Without”: a uniform liquid state without precipitation of solids.

“With”: completely dried with precipitation of solids or a liquid state with precipitation of solids.

As shown in Table 3, in the cleaning solution (CLN-1) having the HSP distance between glycerin and a polyacrylic acid salt of exceeding 10, solids precipitated after two weeks and the dryness was evaluated as “With”. On the other hand, each of the cleaning solutions (CLN-2) to (CLN-5) having the HSP distance between polyethylene glycol and a polyacrylic acid salt of 10 or less was in the uniform liquid state without precipitation of solids, and their dryness was evaluated as “Without”. From these results, it was found that by using polyethylene glycol as an organic solvent and a carboxylic acid salt (e.g., a polyacrylic acid salt) having the HSP distance with polyethylene glycol of 10 or less, the drying of the remaining cleaning solution was suppressed and the precipitation of solids could be suppressed. This is presumably because moisturizing properties of polyethylene glycol suppresses drying and maintains the state in which the carboxylic acid salt is dissolved in polyethylene glycol.

### [Evaluation of Cleaning Performance]

The plate including the ink ejection surface was removed from a recording head (“KJ4B-1200” manufactured by KYOCERA Corporation). This plate was used as an evaluation plate. The above-mentioned ink was ejected onto the ink ejection surface of the evaluation plate using another recording head (“KJ4B-1200” manufactured by KYOCERA Corporation) to form a grid-like dot pattern (1000 dots). The ink was an ink for a low absorption recording medium, such as coated paper, and included a pigment and a resin such as an acrylic resin and a urethane resin. In the formation of the dot pattern, the volume of ink per drop was set to 15 pL (one dot was formed with 15 μL of ink). Next, the evaluation plate was dried at 60° C. for 1 hour. The evaluation plate is a sample that simulates the condition in which the dried ink has adhered to the ink ejection surface of the recording head as stains.

0.1 mL of each of the prepared cleaning solutions was supplied to the above-mentioned evaluation plate (supply amount per unit area: 2.5 L/cm2). Next, the evaluation plate was wiped (line pressure of 10 N/m) at a wiping speed of 20 mm/sec using a rubber wiping blade. Subsequently, after supplying 0.1 mL of each cleaning solution, the evaluation plate was wiped (line pressure of 10 N/m) at 20 mm/sec using the above-mentioned wiping blade, similarly.

After the two times of wiping, the ink ejection surface of the evaluation plate was observed and the number of remaining dots was counted. The removal ratio of dots (100×{1000−the number of remaining dots}/1000) was calculated and the cleaning performance was evaluated on the basis of the following evaluation criteria.

### (Cleaning Performance Criteria)

A (Good): the removal ratio is 90.0% or more.
B (Poor): the removal ratio is 70.0% or more and less than 90.0%.
C (Particularly poor): the removal ratio is less than 70.0%.

As shown in Table 3, in the cleaning solutions (CLN-1) to (CLN-3), the removal ratio of dots was 90.0% or more and their cleaning performance was evaluated as A (Good). On the other hand, in the cleaning solutions (CLN-4) and (CLN-5), the removal ratio of dots was 70.0% or more and less than 90.0%, and their cleaning performance was evaluated as B (Poor). From these results, it was found that by adding a carboxylic acid salt (e.g., a polyacrylic acid salt) and polyethylene glycol having a number average molecular weight of 350 or less, e.g., 400 or less, to a cleaning solution, it was also possible to impart sufficient cleaning performance to inks that include a resin component and are easy to fix.

What is claimed is:

1. A cleaning solution for an inkjet recording apparatus, comprising:
water;
a surfactant;
two or more types of water-soluble organic solvents; and
a carboxylic acid salt other than the surfactant,
the two or more types of water-soluble organic solvents including at least polyethylene glycol,
a Hansen solubility parameter distance between the polyethylene glycol and the carboxylic acid salt being 10 or less.

2. The cleaning solution according to claim 1, wherein
the polyethylene glycol has an average molecular weight of 150 or more.

3. The cleaning solution according to claim 1, wherein
the polyethylene glycol has an average molecular weight of 350 or less.

4. The cleaning solution according to claim 1, wherein
a content of the polyethylene glycol is 3.0 mass % or less.

5. The cleaning solution according to claim 1, wherein
the carboxylic acid salt includes a polymer or copolymer including an acrylic acid salt as a monomer.

6. The cleaning solution according to claim 5, wherein
the polymer or copolymer including an acrylic acid salt as a monomer includes a polyacrylic acid salt.

7. The cleaning solution according to claim 1, wherein
the surfactant includes a surfactant having a betaine structure.
